(19) United States
(12) Patent Application Publication
(10) Pub. No.: US 2005/0003331 A1
(43) Pub. Date: Jan. 6, 2005

(54) System and method for studying a subject area, such as art

(76) Inventor: Stephenie Menzies, Missouri City, TX (US)

Correspondence Address: FULBRIGHT & JAWORSKI, LLP, 1301 MCKINNEY, SUITE 5100, HOUSTON, TX, 77010-3095, US

(21) Appl. No.: 10/838,120

(22) Filed: May 3, 2004

Related U.S. Application Data
(60) Provisional application No. 60/467,352, filed on May 2, 2003.

(51) Int. Cl. G09B 11/00; G09B 5/00

(52) U.S. Cl. 434/81

(57) ABSTRACT

A system and method are provided for the study of a subject area of interest (e.g., art). Such a system includes a plurality of profile cards. Each profile card provides or conveys the characteristics of a group (e.g., artists) within the subject area. For each profile card, at least one corresponding subject flashcard is provided having a first side with a depiction of at least one member of the group (e.g., a work created by the artist). This depiction exhibits the characteristics of the group. The flashcard also has a second portion having thereon, an identifier identifying the depicted member as a member of the group. The profile cards and/or the subject flashcards may be in the form of computer images or some tangible form such as paper or cardboard.

### BACKGROUND OF THE INVENTION

The present invention relates generally to a system and method for the study of a subject area through the use of flashcards. The flashcards may be in tangible form, such as paper or cardboard, or in the form of computer images. The system and method are particularly suited for the study of a subject area such as art, or more specifically, artists and the works of these artists.

The use of flashcards as an educational or entertainment tool has long been known. Pictorial flashcards exist to teach names of objects, colors, shapes, animals, people's roles/occupations, bible characters, body movements (example yoga and ballet), casino games, and subjects such as geography, math, language arts, science, and music. Text flashcards are available in most areas of study, test preparation, certification training, and interview preparation. Text flashcards contain a text question on one portion of the flashcard and the corresponding text answer on another portion of the flashcard. Flashcards are also used to teach concepts such as opposites, matching, and sequencing.

In addition to flashcards, there are numerous other systems available for learning about a particular subject area: books, the internet, games, collectors pieces, and museums to name a few.

### SUMMARY OF THE INVENTION

The present invention relates to a system and method of utilizing flashcards for studying a subject area of interest. The flashcards may be in tangible form, such as paper or cardboard, but the inventive system is adapted for play by computers wherein the flashcards are in the form of computer images. For ease of description, the invention is herein described in terms of the tangible form of flashcards. The system includes a set of profile cards and, for each profile card, a number of corresponding subject flashcards. A subject area of interest may be categorized by one or more groups. By way of example, the subject area of art may be categorized by artist, the subject area of animals may be categorized by phylum, and the subject area of cars may be categorized by manufacturer. There are, of course, a variety of ways that a subject area of interest may be categorized. For each selected group within the subject area of interest to be taught to the user, there will be one or more profile cards that identify that particular group and provide information on at least one characteristics of that group. The corresponding subject flashcards will each depict one member of the group on one side of the card and will further provide an identifier identifying the depicted member as a member of the group. Preferably, the identifier is separately viewable from the depicted member.

For example, if the set of cards is aimed at teaching the user about animals, animals may be categorized by the various phyla, for example. Each of the profile cards would list certain at least one selected characteristic of each selected phylum. The profile card for the arthropods, one of the animal phyla, might describe an arthropod as a segmented animal with more than four jointed legs and having a hard covering over the whole body. The subject flashcards corresponding to this profile card would each depict an illustration of one member of the arthropod group, such as one type of insect, on one side of the subject flashcards and would identify the insect as a member of the arthropod group on a separately viewable portion of the subject flashcard.

Additionally, the present invention relates to the utilization of the flashcard system to (1) teach users about the different groups contained with in a subject area of interest; (2) teach users about certain selected characteristics of each group; (3) teach users how to recognize the members of each group included in the flashcard collection; and (4) help users develop the ability to recognize members of the group not included in the flashcard collection.

### BRIEF DESCRIPTION OF THE DRAWINGS

FIG. 1 is a view of one side of a profile card;

FIG. 2 is view of one side of a subject flashcard;

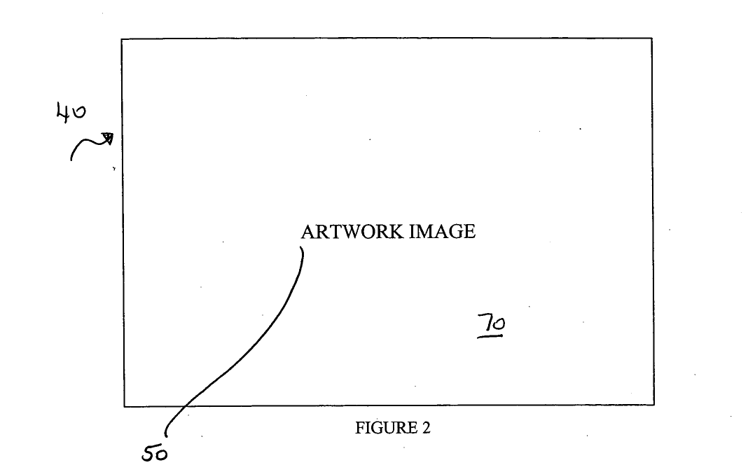

FIG. 3 is view of another side of the subject flashcard of FIG. 2;

FIG. 4 is an exemplary view of one side of the profile card of FIG. 1;

FIG. 5 is an exemplary view of another side of the profile card of FIG. 1;

FIG. 6 is an exemplary view of one side of the subject flashcard of FIG. 2; and

FIG. 7 is an exemplary view of another side of the subject flashcard of FIG. 2.

### DESCRIPTION OF THE PREFERRED EMBODIMENTS

The flashcard system is described in more detail using the field of art as an example. It should be noted, however, that the various aspects of the system and/or method are equally applicable for the study of other subject areas and groups. Such other applications will be readily apparent to one skilled in the relevant art upon a reading of the present disclosure and a viewing of the accompanying drawings. Using the field of art as the subject area, various artists constitute the different groups and the creations of those artists constitute the members of the group. There will, therefore, be a profile card for each of the selected artists and subject flashcards containing artwork corresponding to each of the artists who is the subject of a profile card.

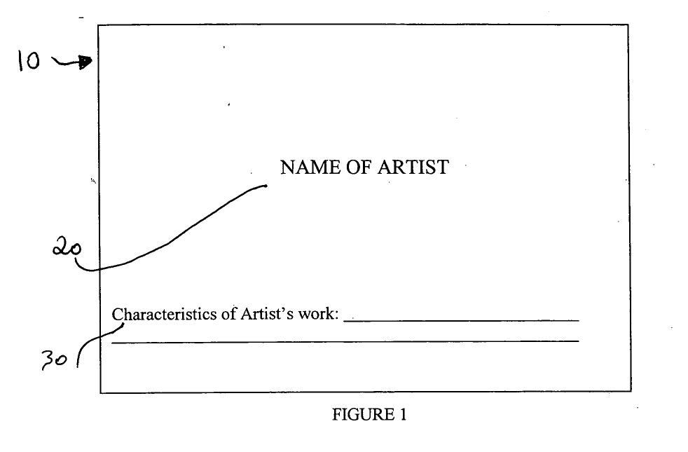

Each profile card (10) identifies the artist (20) and lists at least one selected characteristic (30) of the artist which may be used to differentiate the artist from other artists. The characteristics may include, for example, the artist's unique or dominant subject, style, technique, or color preference found in his or her artworks. With reference to FIG. 1, the subject, for example, may be described in terms of the objects and subjects typically painted by the artist, the typical activities of the subjects painted, particular influences seen in the artist's paintings, or specific themes seen throughout the body of the artist's work. The style may be described in terms of painting techniques used, such as delicate strokes of paint, recurring arrangements or special effects. The characteristic or set of characteristics selected will be such that those characteristics are sufficient for the user to be able to review and/or learn about the characteristics that identify that particular artist and distinguish him or her from other artists. These artist profile cards will serve as a study tool before using the subject flashcards and can be used as a reference as needed. The invention is particularly suited for study of a subject area such as the visual arts, wherein the groups of the subject area are primarily identified by a set of visually observable characteristics as in, for example, the subject area of art.

Each subject flashcard (40) depicts on its first side (70) a work of art (50) of the artist (20) who is the subject of the profile card (10). The work of art is selected from the numerous works of art of that artist and represents the unique or dominate subject, style, technique, or color preference that characterizes and identifies that artist's work. It is intended that, preferably, there are two or more subject flashcards corresponding to each profile card. Thus, the subject flashcards themselves are a collection of art.

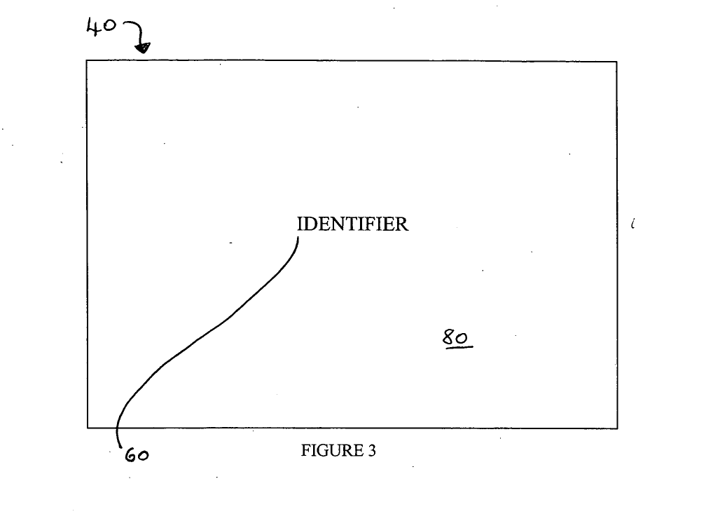

As shown in FIG. 3, the subject flashcards include an identifier (60) which identifies the art work (50) as a work of art of the artist (20). Preferably, the identifier (60) is separately viewable from the depiction (50) so that the user does not view the identifier (60) at the same time as the depiction (50). In the preferred embodiment of FIG. 3, the identifier (60) is provided on a second side (80) of the subject flashcard. However, the identifier may be positioned on the first side (70) of the subject flashcard and covered with an element that is attached to or formed from the first side and that is operable to reveal the identifier. The cover may be in the form of a flap that can be lifted by the user to reveal the identifier.

The subject flashcards corresponding to each profile card should contain multiple pieces of artwork from each artist to ensure the user has adequate exposure to the work of the selected artists. The collection of profile cards and subject flashcards should contain multiple artists to enhance learning through contrast, thus allowing the individual to learn to recognize and identify the artwork of each artist in the collection.

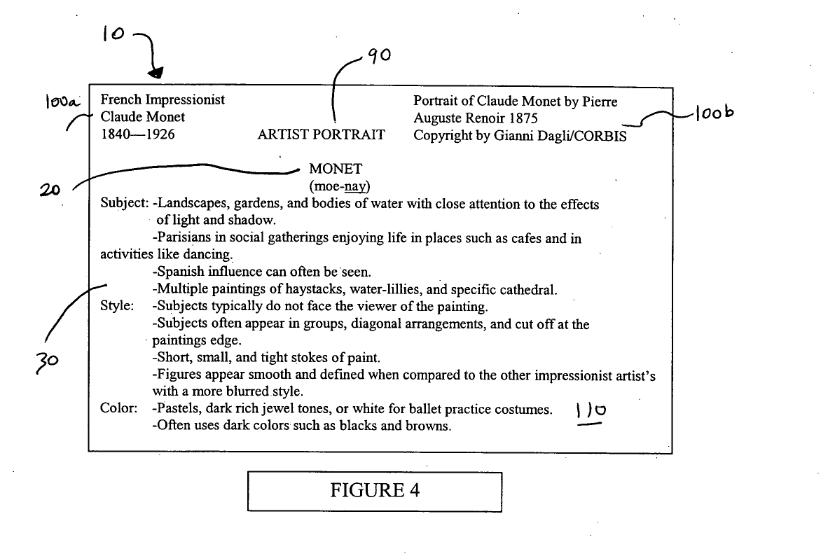

FIGS. 4-7 illustrate one embodiment of the flashcard system in which the profile cards (10) and the subject flashcards (40) are in tangible form. In this exemplary embodiment, the subject area is art, more particularly master impressionists. The subject area may be categorized, in one alternative, by artists. The first side (110) of each profile card contains the name of the artist (20) and selected characteristics (30) that identify the artists work. In the particular embodiment of FIG. 4, the artist is Monet and the qualities characteristic of Monet's work are described in terms of subject, style, color and medium. With reference to FIG. 4, the subjects characteristic of Monet's work include landscapes, gardens, and bodies of water with close attention to the effects of light and shadow; multiple paintings of haystacks, water-lilies, Paris train station and Rouen cathedral. In terms of style, Monet's subjects are not over defined, but instead are even more blurred and loose in appearance when compared to the other impressionist artist's with a more defined style. As shown on FIG. 4, the colors used by Monet are typically light pastels, yet colorful. The medium used by Monet is oil on canvas. As another example, another member of the group is Mary Cassatt. Characteristic of Cassatt are portraits of the daily activities of women and children; portraits showing the bond between mother and baby/young child; and portraits of women socializing. Further, Cassatt's works of art are characterized by bright colors, and at times are almost shiny in appearance.

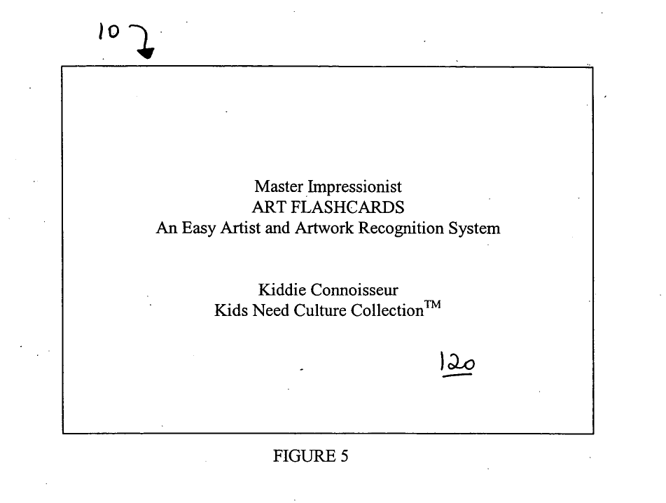

In addition to the artist name (20) and characteristics (30), the cards may also include a portrait of the artist (90) as well as additional information (100). As shown in FIG. 4, the following is an example of the information that may be included: artist's nationality, art period, artist's full name, artist's date of birth and date of death, title and date of portrait of artist, museum or place of residence, and pronunciation of artist's name. This list is not intended to limit the types of information that may be included but to illustrate the additional information that may be made part of the profile card (10). FIG. 5 shows one embodiment of the second side (120) of the profile card. This embodiment includes information related to the product itself, but may contain other information of interest, such as additional artist facts or stories not key to the system's teachings.

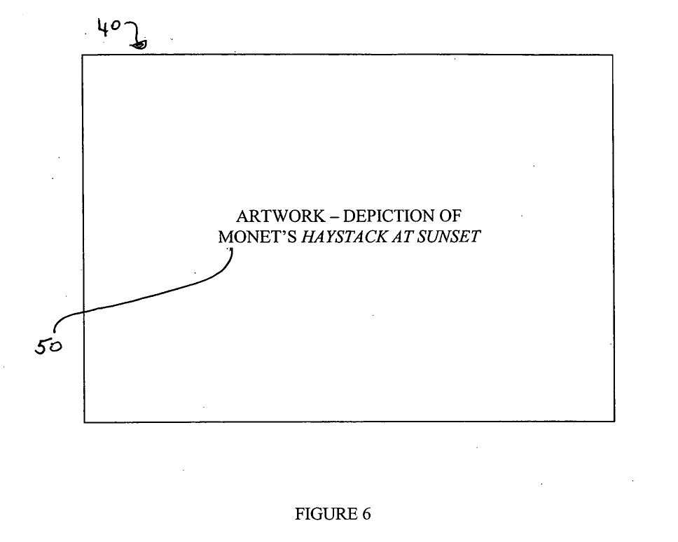

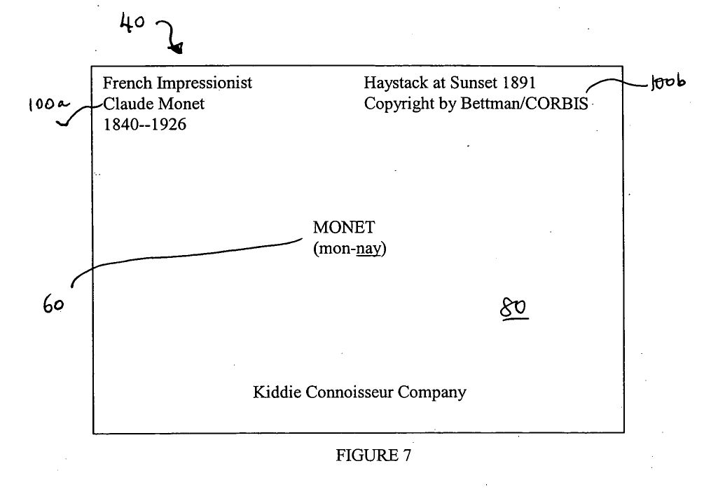

As shown in FIGS. 6-7, an exemplary embodiment of the subject flashcard would depict a work of art (50) of one of the artists in the profile cards on a first side (70) of the subject flashcards and an identifier (60) identifying the depiction (50) as a work of art of the artist on the second side (80) of the subject flashcard. The identifier (60), the name of the artist who created the work, is concealed from the depiction (50) itself so as not to disclose the identity of the creator of the artwork when the user is viewing the depiction. The subject flashcards may include other information (100) in addition to the depiction and the identifier. As shown in exemplary FIG. 7, the second side of the subject flashcard may include: artist's nationality, art movement or period, artist's full name, artist's date of birth and date of death, artist's last name, company name, title and date of artwork, image copyright information, museum or place of residence. The number of subject flashcards per artist can vary but must be enough to emphasize the characteristics of the profile card.

To practice the method of this invention, the user observes and/or studies each of the profile cards included in the flashcard system. The user then reviews the front of each of the subject flashcards and, drawing on the criteria presented in the profile cards, attempts to identify the artist. The user verifies the correctness of his or her response by reviewing the information on the separately viewable portion of the subject flashcard. The flashcard system can be displayed to oneself or a to a group. The flashcard system can be viewed multiple times and in varying sequence until the artist recognition becomes immediate and is incorporated to memory, resulting in the eventual ability to recognize and identify the works of a particular artist in the collection. Furthermore, through use of the system is that a user can develop the ability to venture an educated guess when attempting to identify artwork as that of an artist in the collection even when that artwork is not included in the collection. This additional benefit is reaped by the individual as a result of learning the artists' unique or dominate subject, style, technique, or color preference instead of simply memorizing the artists' name and title of the artwork. This system allows the individual to become confident in their knowledge of the scope of works covered by the flashcard system. Additional artwork information, such as the name of the piece of art, is included on the back of the flashcards for advanced study when possible.

Further directions for initial study include:
1. Study the artist profile cards in any order. After initial study, keep the profile cards covered or turned over until they are needed for further reference.
2. Begin viewing the subject flashcards in any order, by looking at the image on the front of the selected flashcard. State the artist's name that created the artwork.
3. Turn to the portion of the flashcard containing the identifier to verify if the answer is correct or incorrect.
4. If correct, place the subject flashcard at the back of the stack of subject flashcards. Now view the next subject flashcard and repeat the procedures. If incorrect, look at the corresponding artist profile card to study and learn why the answer is incorrect and to reinforce what differentiates that artist from the others. Then place the subject flashcard at the back of the stack of subject flashcards and the profile card back at the back of the stack of profile cards. Continue with the next subject flashcard and repeat the procedures.

Further directions for advanced study include:
1. Using the subject flashcards, study the images on the front of the flashcards and the corresponding artwork titles and additional information found on the back of the flashcards.
2. Drill the flashcards in any order, by looking at the image on the front of the selected flashcard and state the title and other information.
3. Turnover to the back of the flashcard to verify if the answer is correct or incorrect.
4. If correct, place the flashcard at the back of the stack of subject flashcards and move on to the next subject flashcard and repeat the procedure. If incorrect, re-study the image and corresponding information and then place the flashcard at the back of the stack of subject flashcards and move onto the next flashcard.

Other overall instructions include:
1. Remember to shuffle the subject flashcards often to vary sequence to prevent remote memorization.
2. A flashcard may be temporarily discarded or removed to further focus study on flashcards that need additional study.

Flashcards are known as a memory tool used by students to learn and retain information. A flashcard may have any shape, size, or material of construction, but generally is a relatively small, for instance a 3×5, flat, two-sided piece of stiff paper. The flashcard typically has a front or “cue” side on which a question or item of interest is written, printed, or the like, and a back or “response” side which contains the answer. Alternatively, flashcards may be in the form of computer images. The student, through the use of flashcards, can test their memory with regards to the questions or items of interest and the corresponding answers. Yet a further advantage of flashcards is that their order may be altered to prevent a rote memorization response, and they may be temporarily discarded or removed from the set once learned or no longer of primary relevance. Flashcards may need to be reviewed only on some infrequent basis to strengthen recollection.

The present invention can be adapted for play by computer. The computer version of the system includes a set of computer images for the profile card information and for the depictions and information of the subject flashcards. The presentation of the images of the computer version of the flashcard system may be manual or may be automated.

The present invention has several advantages over existing systems and methods of learning a subject area of interest in that it separates the information regarding how to identify a group from examples of the group and it allows users to identify some members of a group not specifically presented in the collection. In addition, the information presented is focused on exactly what one needs to know to learn the characteristics of a particular group, such as, for example, an particular artist, whereas other systems, such as books, for example, provide a large scope of information to build general knowledge about a group and its members. In addition, the flashcard system of the present invention conceals the identification of the group to which the member belongs unlike, for example, postcards containing art prints that readily identify the name of the artist. Further, the system has the goal of specifically teaching the skill to recognize a member of a group based on its characteristics in contrast to other systems that may provide exposure or encourage memorization of group members without going the extra step of a focused system that teaches one to recognize the characteristics of a group and be able to recognize multiple members of the group based on those characteristics even if those particular members are not included in the subject flashcards.

The foregoing description of the present invention has been presented for purposes of illustration and description. It is to be noted that the description is not intended to limit the invention to the various apparatus and processes disclosed herein. The focus of the flashcard system could be any subject area which can be divided into groups, each group having certain characteristics that differentiate one group from another. Such variations of the invention will become apparent to one skilled in the relevant consumer products, or other relevant art provided with the present disclosure. Consequently, variations and modifications commensurate with the above teachings, and the skill and knowledge of the relevant art, are within the scope of the present invention. The embodiments described and illustrated herein are further intended to explain the best modes for practicing the invention, and to enable others skilled in the art to utilize the invention and other embodiments and with various modifications required by the particular applications or uses of the present invention.

1. A system for the study of a subject area of interest, said system comprising:
one or more profile cards, each profile card identifying a particular group within the subject area and providing one or more selected characteristics of said group; and
for each profile card, at least one corresponding subject flashcard having a first side with a depiction of at least one member of the group, the depiction exhibiting one or more of said selected characteristics of the group, and a portion having thereon, an identifier identifying the depicted member as a member of the group.

2. The system of claim 1, wherein said identifier is separately viewable from said depiction.

3. The system of claim 2, wherein said portion is a second side of said subject flashcard.

4. The system of claim 2, wherein said portion is positioned on the first side of the profile card; said portion having an element that is attached to or formed from the first side to conceal the identifier; and said portion further being operable to reveal the identifier.

5. The system of claim 1, wherein said profile cards and said subject flashcards are in tangible form.

6. The system of claim 1, wherein said profile cards are computer images stored in a computer database and said subject flashcards are computer images stored in a computer database.

7. A system for the study of a subject area of interest, said system comprising:
one or more first computer images, each first computer image identifying a particular group within the subject area of interest and conveying one or more selected characteristics of said group; and
for each first computer image, at least one corresponding second computer image depicting at least one member of the group, the depiction exhibiting one or more of said selected characteristics of said group; and
for each second computer image, a third computer image having thereon an identifier identifying the depicted member as a member of the group.

8. The system of claim 7, wherein the subject area is art, and wherein each first computer image presents an artist, and each one or more of said corresponding second images depicts a work of art by the artist and each of said third computer images has an identifier identifying the depicted member as a member of the group.

9. The system of claim 8, further comprising one or more computer databases storing said first computer images, said second computer images, and said identifiers; and
an executable computer program for selectively prompting said images and said identifiers; and
a data processing system for executing said program.

10. A system for the study of a subject area of interest, said system comprising:
one or more profile cards, each profile card identifying a group within a visual subject area and describing one or more selected visually observable characteristics of the group; and
for each profile card, at least one corresponding subject flashcard having a first side with a depiction of at least one member of the group, the depiction exhibiting one or more of the visually observable characteristics of the group, and a portion having thereon, an identifier identifying the depicted member as a member of the group.

11. The system of claim 10, wherein said groups of the subject area belong to a distinct category of the subject area.

12. The system of claim 11, wherein said subject area is artwork associated with a selected period or style, and said groups are selected artists authoring artwork of selected period or style.

13. The system of claim 12, wherein said portion is separately viewable from said depiction.

14. The system of claim 13, wherein the profile cards and the subject flashcards are in tangible form

15. The system of claim 14, wherein said portion is a second side of the subject flashcard.

16. The system of claim 12, wherein the profile cards and the subject flashcards are in the form of computer images.

17. A method of studying a subject area of interest utilizing a flashcard system, said method comprising:
providing one or more profile cards, each profile card identifying a particular group within the subject area of interest and conveying one or more selected characteristics of said group; providing one or more corresponding subject flashcards for each profile card, each corresponding subject flashcard having a depiction of at least one member of the group, the depiction exhibiting selected characteristics of the group and a separately viewable identifier identifying the depicted member as a member of the group;
using the profile card to study the characteristics of a group within the subject area of interest;
viewing the depiction of the subject flashcard, including observing the characteristics of the depiction in the subject flashcard; and
associating or disassociating the depicted member with the group provided in the profile card, by comparing the observed characteristics with the characteristics conveyed by the profile card.

18. The method of claim 17, wherein the user views the identifier contained on the subject flashcard to determine if the correct association or disassociation was made.

19. The method of claim 17, wherein the flashcards, the profile cards, and viewable identifiers are provided as computer images, said using, viewing, and comparing steps being performed through operation of a microprocessor-based machine.

20. The method of claim 17, wherein said subject flashcards, said profile cards, and said viewable identifiers are in tangible form, said viewing step including viewing the viewable identifier on a side of the flashcard opposite of the depiction.

21. The method of claim 17, wherein said subject flashcards and said profile cards are in tangible form, said viewing step including revealing the viewable identifier by operating an element that is attached to or formed from the first side of the subject flashcard.
